(19) United States
(12) Patent Application Publication
(10) Pub. No.: US 2015/0226630 A1
(43) Pub. Date: Aug. 13, 2015

(54) AIRTIGHTNESS EVALUATION DEVICE AND AIRTIGHTNESS EVALUATION METHOD

(71) Applicant: Satoshi Nakagawa, (US)

(72) Inventor: Satoshi Nakagawa, Tokyo (JP)

(73) Assignee: MITSUBISHI ELECTRIC CORPORATION, Tokyo (JP)

(21) Appl. No.: 14/424,308

(22) PCT Filed: Oct. 18, 2012
(86) PCT No.: PCT/JP2012/076961

§ 371 Date: Feb. 26, 2015

(51) Int. Cl. G01M 3/22; F02M 25/08

(52) U.S. Cl. CPC G01M 3/223; F02M 25/08

(57) ABSTRACT

In a case where air pump system evaluation is performed, an ECU 15 blocks a pipe 5 from atmosphere by closing a canister vent solenoid valve 11, and drives an air pump 12 to pressurizes the pipe 5 up to a target pressure, and then provides a state sealing the pipe 5 by stopping the air pump 12 and closing a check valve 13, and airtightness thereof is evaluated on the basis of a pressure variation measured by a pressure gauge 6. In a condition under which the driving of the air pump 12 is desired to be avoided, EONV system evaluation is performed, and the airtightness is evaluated on the basis of a natural pressure variation resulting from a temperature change in the pipe 5 at the time when the canister vent solenoid valve 11 and the check valve 13 are closed.

### TECHNICAL FIELD

The present invention relates to an airtightness evaluation device and an airtightness evaluation method that evaluate the airtightness of an evaporated fuel processing system.

### BACKGROUND ART

Recently, as methods of evaluating pipe leakage of evaporated fuel in a vehicle, methods of evaluating the presence or absence of the pipe leakage by sealing a pipe and monitoring a pressure variation at the time of application of a pressure (positive pressure or engine vacuum) into the pipe become the main stream. Furthermore, these methods are roughly categorized into three types of an engine vacuum system, an EONV (Engine Off Natural Vacuum) system, and an air pump system, depending on differences in pressure application methods.

First, the engine vacuum system is a method of evaluating the presence or absence of the pipe leakage by depressurizing the inside of the pipe with an engine vacuum, and thereafter sealing the pipe and monitoring a pressure variation thereof. In the case of this method, fewer components are required to configure a system and the system can be configured at lower cost; however, the evaluation can be carried out only during engine driving, and hence a timing providing a stable state that enables the evaluation is limited.

The EONV system is a method of evaluating the presence or absence of the pipe leakage by monitoring a variation in pipe pressure resulting from a change in a fuel temperature after the stop of an engine (stop of a vehicle). Similarly to the engine vacuum system, the number of system components is reduced, and the system can be configured at lower cost. However, because fuel heating by engine waste heat and fuel cooling by natural heat radiation are used, the evaluation takes time. As a result, power consumption during the evaluation is increased.

Furthermore, the engine vacuum system and the EONV system is predicated on the engine driving; hence, in a vehicle such as plug-in hybrid vehicle in which the engine driving itself is implemented fewer times, the evaluation cannot be performed.

Finally, in the air pump system (e.g., see Patent Documents 1 to 3), after a pipe is sealed, an air pump is driven to apply a pressure to the pipe, and leakage evaluation thereof is performed. There are two ways of a method of evaluating the leakage by monitoring a pressure gradient during the pressure application (during the driving of an air pump) (requiring a high-precision air pump), and a method of evaluating the leakage by comparing a load of a reference orifice with a load of a pipe (requiring a high-precision orifice). Furthermore, for a determination of the loads, there are the following two types: the one utilizing a current value of a motor for air pump driving; and the one utilizing a pressure sensor.

The air pump system does not depend on an engine, and therefore the leakage evaluation can be performed when needed, regardless of an engine driving state. On the other hand, precise components are needed, and therefore the components themselves are expensive. Additionally, there are concerns that evaporated fuel flows in the motor for air pump driving, and therefore the cost is increased by performing a countermeasure such as employment of an explosion proofed motor.

### CITATION LIST

### Patent Documents

Patent Document 1: Japanese Patent Application Laid-open No. 2000-186633

Patent Document 2: WO 2005/1273

Patent Document 3: Japanese Patent Application Laid-open No. 2005-98125

### SUMMARY OF THE INVENTION

### Problems to be Solved by the Invention

As described above, the engine vacuum system and the EONV system have a problem such that the evaluation cannot be performed depending on the engine driving state. On the other hand, the air pump system has a problem such that the high-precision air pump and so on are required, and the cost is increased.

The present invention has been made in order to solve the above problems, and therefore an object of the present invention is to provide an airtightness evaluation device and an airtightness evaluation method capable of evaluating the airtightness of an evaporated fuel processing system at a low cost without being affected by the engine driving state.

### Means for Solving the Problems

An airtightness evaluation device of the present invention includes: an air pump that changes an internal pressure of an evaporated fuel processing system; a solenoid valve that is installed in a pipe which communicates a canister with atmosphere; and a controller that performs driving control of the air pump and opening/closing control of the solenoid valve, and detects the internal pressure of the evaporated fuel processing system to evaluate airtightness thereof, wherein in a case where a predetermined condition is satisfied, the controller drives the air pump to pressurize or depressurize the internal pressure in a state blocking the evaporated fuel processing system from the atmosphere by closing the solenoid valve, and then performs a first evaluation system of evaluating the airtightness on the basis of a variation in the internal pressure in a state stopping the air pump, whereas in a case where the predetermined condition is not satisfied, the controller performs a second evaluation system of evaluating the airtightness on the basis of the variation in the internal pressure in the state blocking the evaporated fuel processing system from the atmosphere by closing the solenoid valve.

An airtightness evaluation method of the invention includes: in a case where a predetermined condition is satisfied, providing a state blocking an evaporated fuel processing system from atmosphere by closing a solenoid valve installed in a pipe that communicates a canister with the atmosphere, and driving an air pump to pressurize or depressurize an internal pressure of the evaporated fuel processing system, and then performing a first evaluation system of evaluating airtightness thereof on the basis of a variation in the internal pressure in a state stopping the air pump, whereas in a case where the predetermined condition is not satisfied, performing a second evaluation system of evaluating airtightness on the basis of the variation in the internal pressure in the state blocking the evaporated fuel processing system from the atmosphere by closing the solenoid valve.

### Effect of the Invention

According to the present invention, the first evaluation system using the air pump is mainly performed, so that the frequency of the second evaluation system (an engine vacuum system or an EONV system) that is affected by an engine driving state can be reduced, and the airtightness can be evaluated without being affected by the engine driving state. In addition, in the first evaluation system, the airtightness is evaluated not on the basis of a variation in an internal pressure during pressurization or depressurization as in the conventional, but on the basis of the variation of the internal pressure after the pressurization or depressurization, and therefore components such as a high-precision air pump are not required, and the airtightness evaluation device can be configured at a low cost.

### BRIEF DESCRIPTION OF THE DRAWINGS

FIG. 1 is a figure showing a configuration of an evaporated fuel processing system to which an airtightness evaluation device according to Embodiment 1 of the present invention is applied.

FIG. 2 is a figure showing a state of the evaporated fuel processing system of Embodiment 1 during EONV system evaluation.

FIG. 3 is a graph showing a relation between EONV system evaluation pressure and opening valve pressure of a check valve of the airtightness evaluation device according to Embodiment 1.

FIG. 4 is a figure showing a state of the evaporated fuel processing system of Embodiment 1 during air pump system evaluation.

FIG. 5 is a figure showing a state of the airtightness evaluation device in a case where an excessive pressure is generated during the air pump system evaluation.

FIG. 6A is a flowchart showing an operation of the airtightness evaluation device according to Embodiment 1.

FIG. 6B shows the continuation of the flowchart of FIG. 6A.

FIG. 7 is a graph of a pressure curve used in the air pump system evaluation by the airtightness evaluation device according to Embodiment 1.

FIG. 8 is a figure showing a modification of the airtightness evaluation device according to Embodiment 1.

### MODES FOR CARRYING OUT THE INVENTION

In the following, in order to describe the present invention in more detail, embodiments for carrying out the invention will be described with reference to the accompanying drawings.

### Embodiment 1

An evaporated fuel processing system shown in FIG. 1 is configured by a fuel tank 1, a canister 2 that absorbs and temporarily stores fuel evaporated in the fuel tank 1, an inlet manifold 3 that introduces to an engine the evaporated fuel recovered in the canister 2, an NC (Normally Close) type purge solenoid valve 4 that controls a flow rate of the evaporated fuel, and a pipe 5 that communicates from the fuel tank 1 to the purge solenoid valve 4 through the canister 2.

In FIG. 1, an airtightness evaluation device 10 is a product that is used in order to detect the leakage of the evaporated fuel in the evaporated fuel processing system;
in order to ensure the number of evaluations regardless of a driving state of the engine, it is configured to mainly perform an evaluation of an air pump system (first evaluation system), and to be capable of performing also an evaluation under an EONV system (second evaluation system) by devising a configuration of components for the evaluation.

The components for evaluation that configure this airtightness evaluation device 10 are configured by an NO (Normally Open) type canister vent solenoid valve 11, an air pump 12, and a check valve 13. In addition, one end of a component pipe 14 is connected to the pipe 5 on the canister 2 side, and the other end is opened to the atmosphere side through a filter (not shown). A range in which the leakage evaluation is performed is a space configured by the fuel tank 1, the canister 2, and the pipe 5 that connects from the fuel tank 1 to the purge solenoid valve 4 through the canister 2.

When the canister vent solenoid valve 11 urges a valve body in a valve closing direction by an urging member such as a spring, and flows a current in a solenoid coil, the valve body is driven in a valve opening direction against the valve closing force of the urging member to communicate the canister 2 with the atmosphere side. The air pump 12 compresses the air by the driving of a motor, discharges the compressed air to the pipe 5 through the check valve 13, and pressurizes the pipe 5. The check valve 13 is installed between the canister 2 and the air pump 12, and opens/closes in accordance with a differential pressure between the canister 2 side and the air pump 12 side.

An ECU (Electronic Control Unit; controller) 15 performs the opening/closing control of the canister vent solenoid valve 11 and the driving control of the air pump 12, and evaluates the airtightness of the pipe 5 on the basis of the pressure in the pipe 5 measured by a pressure gauge 6, the temperature in the pipe 5 measured by a thermometer 7, and the like. Incidentally, in FIG. 1, the pressure gauge 6 and the thermometer 7 are installed in the fuel tank 1, but it is not limited to this, and the pressure gauge and thermometer may be installed at any place where the temperature and the pressure of the pipe 5 as an object of the leakage evaluation can be measured.

In order to perform the evaluation of the air pump system and the evaluation of the EONV system with a low-cost configuration, the relation among the discharge pressure of the air pump 12, the opening valve pressure of the check valve 13, and the evaluation pressure of the EONV system satisfies the following expression (1).

|Discharge Pressure of Air Pump|>|Opening Valve Pressure of Canister Vent Solenoid Valve|>|Air Pump System Evaluation Pressure|>|Opening Valve Pressure of Check Valve|>|EONV System Evaluation Pressure| (1)

In the above expression (1), the evaluation pressure of the EONV system indicates values of a natural pressure variation in accordance with a change in the internal temperature of the pipe 5 in a state where the purge solenoid valve 4 and the canister vent solenoid valve 11 are closed to seal the pipe 5. The evaluation pressure of the air pump system is a target value of the pipe internal pressure at which the presence or absence of the leakage of the pipe 5 can be evaluated. In the state where the purge solenoid valve 4 and the canister vent solenoid valve 11 are closed to seal the pipe 5, the air pump 12 is driven, and the internal pressure of the pipe 5 is pressurized until the internal pressure reaches the air pump system evaluation pressure.

In the above expression (1), in the event that the pressure of the pipe 5 becomes excessive due to failure of the air pump 12, failure of the pressure gauge 6, or the like, the valve closing force of the canister vent solenoid valve 11 is set to such a degree as to open the valve at a predetermined abnormal pressure so that the canister vent solenoid valve 11 can be opened to release the pipe internal pressure.

However, in the above expression (1), in a case where the failure of the air pump 12 or the like is not considered, by establishing at least the relation of the following expression (1A), in each of the air pump system evaluation and the EONV system evaluation, the check valve 13 seals the pipe 5, and thus airtightness evaluation based on a variation in the internal pressure can be performed.

51 Discharge Pressure of Air Pump|>|Opening Valve Pressure of Check Valve|>|EONV System Evaluation Pressure| (1A)

Additionally, the air pump system evaluation pressure is not necessarily set to a value greater than the opening valve pressure of the check valve 13, but may be set to a value lower than the opening valve pressure of the check valve 13 (e.g., almost the same as the EONV system evaluation pressure). This is because in a case where the pipe 5 is pressurized by the air pump system evaluation, if the check valve 13 is opened by the discharge pressure of the air pump 12, and the air can be fed into the pipe 5, the internal pressure of the pipe 5 can be arbitrarily pressurized by an amount of the fed air.

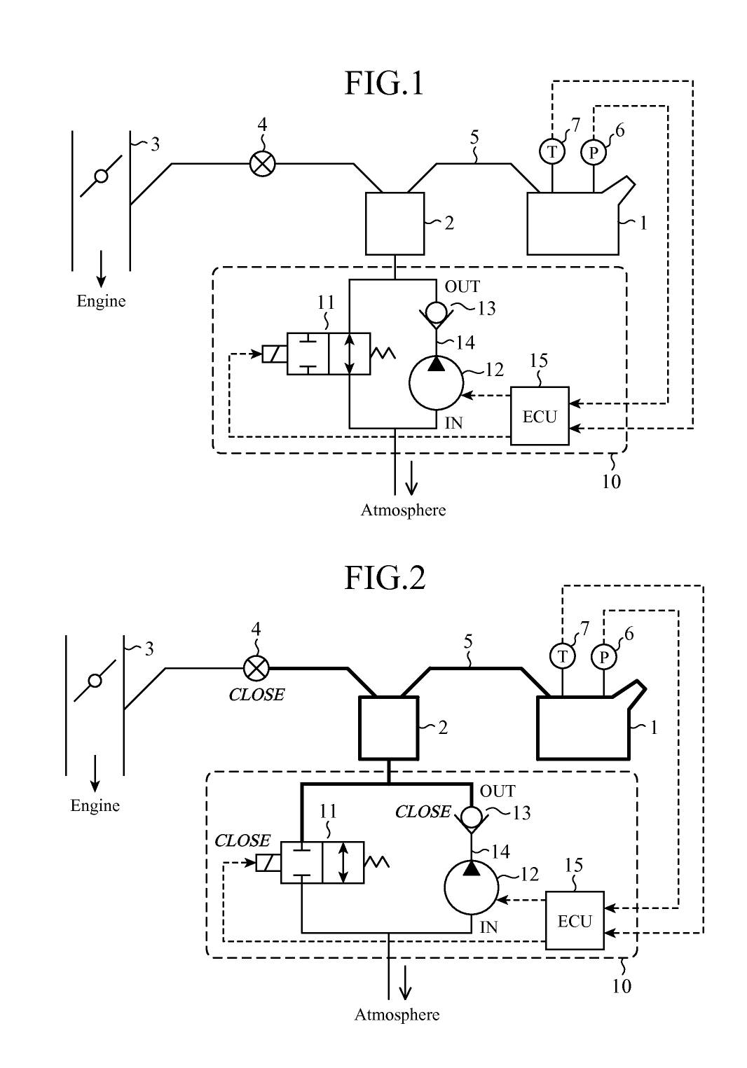

FIG. 2 is a figure showing a state of the evaporated fuel processing system during the EONV system evaluation. During the evaluation of the EONV system, the engine is stopped, and the purge solenoid valve 4 is closed. In the airtightness evaluation device 10, the canister vent solenoid valve 11 is closed by the control of the ECU 15.

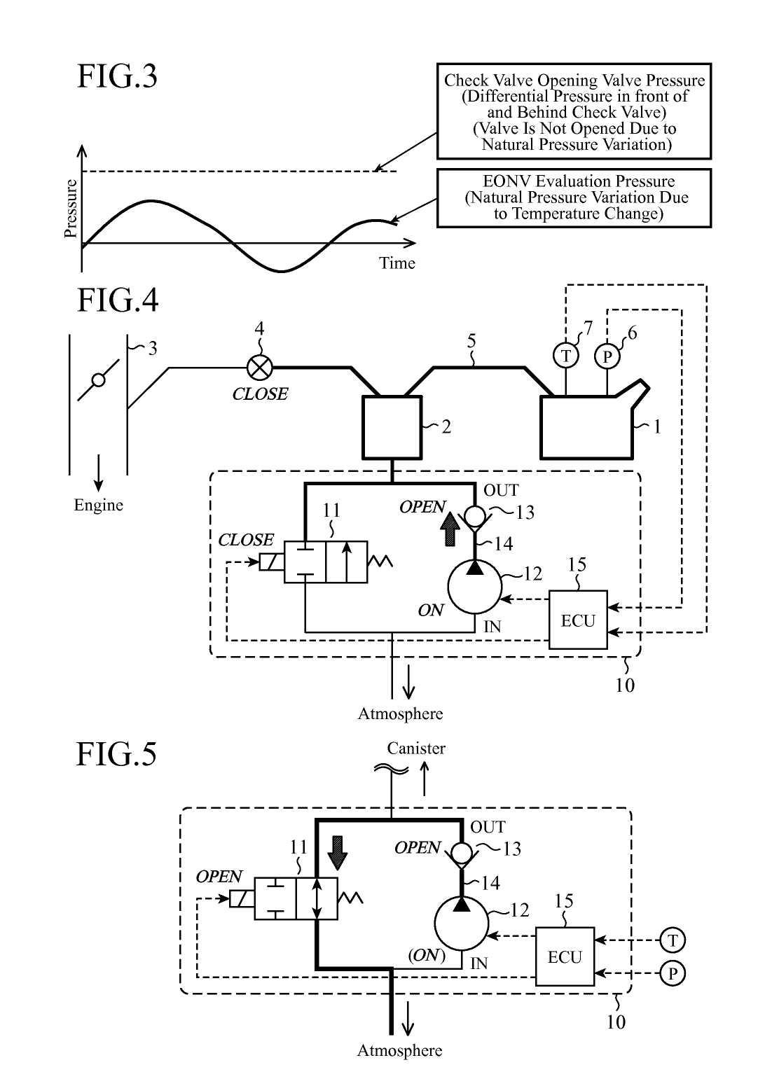

FIG. 3 is a graph showing a relation between the EONV system evaluation pressure and the opening valve pressure of the check valve 13. The horizontal axis of the graph shows time, and the vertical axis thereof shows pressure. The opening valve pressure of the check valve 13 shown by a broken line, namely, the differential pressure between the pipes 5 and 14 in front of and behind the check valve 13 is set to a value higher than the EONV system evaluation pressure (according to the above expression (1)), and therefore during the evaluation of the EONV system, the check valve 13 is not opened while the pipe internal pressure of the pipe 5 naturally varies in accordance with change in the temperature. Accordingly, in a case where the evaluation of the EONV system is performed, the pipe system shown by a thick line in FIG. 2 is brought into a sealed state; hence the airtightness can be evaluated on the basis of the variation in the pipe internal pressure in accordance with fuel heating by engine waste heat and fuel cooling by natural heat radiation.

FIG. 4 is a figure showing a state of the evaporated fuel processing system during the air pump system evaluation. When the air pump system evaluation is performed, the purge solenoid valve 4 is closed in the evaporated fuel processing system. Additionally, in the airtightness evaluation device 10, the canister vent solenoid valve 11 is closed by the control of the ECU 15. Furthermore, the air pump 12 is driven by the control of the ECU 15, the check valve 13 is opened by the discharge pressure of the air pump 12 (according to the above expression (1)), and the pipe 5 is pressurized up to the air pump system evaluation pressure. Accordingly, in a case where the evaluation of the air pump system is performed, the pipe system shown by a thick line in FIG. 4 is brought into the sealed state; hence the airtightness can be evaluated on the basis of the pipe internal pressure dropping from the air pump system evaluation pressure.

FIG. 5 is a figure showing a state of the airtightness evaluation device 10 in a case where an excessive pressure is generated during the air pump system evaluation of the evaporated fuel processing system. In a case where the pressure of the pipe 5 abnormally rises due to the failure of the air pump 12, the failure of the pressure gauge 6, or the like, the canister vent solenoid valve 11 is opened to release the pressure.

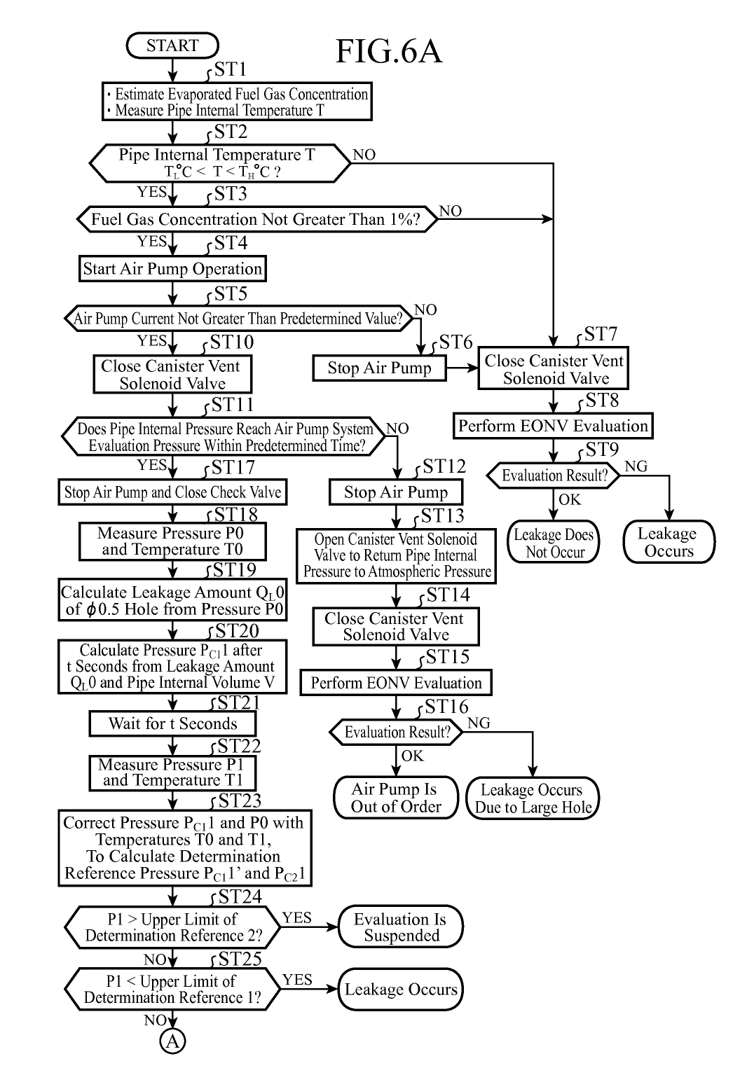

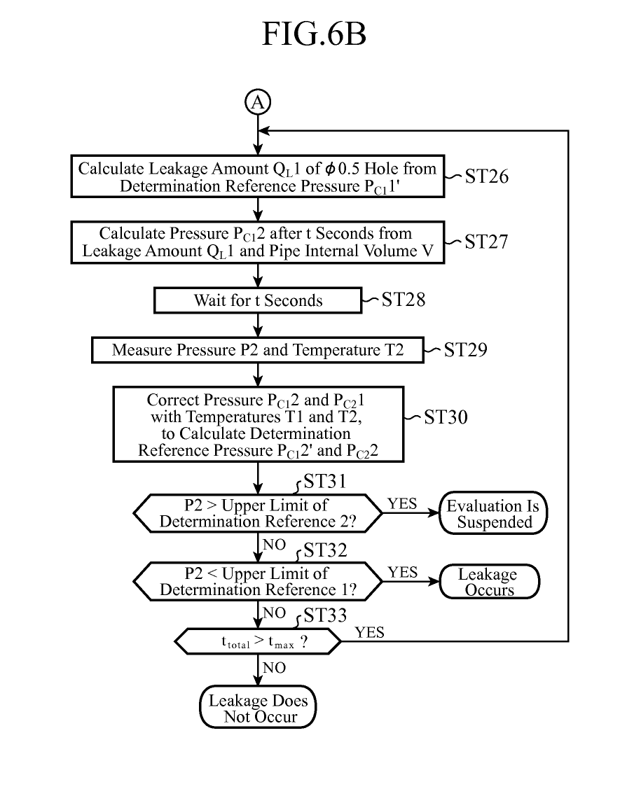

An operation of the airtightness evaluation device 10 will be now described with reference to flowcharts of FIG. 6A and FIG. 6B.

In a case where the airtightness evaluation of the evaporated fuel processing system is performed, the ECU 15 first determines whether or not a predetermined condition is satisfied (Steps ST1 to ST5). In a case where the predetermined condition is satisfied, the evaluation of the air pump system is performed. In a case where the predetermined condition is not satisfied, the evaluation of the EONV system is performed. In the examples of FIG. 6A and FIG. 6B, under a normal atmosphere environment, the air pump 12 applies a pressure, the airtightness evaluation is performed, and the presence or absence of the leakage of the pipe is determined in a short period of time. On the other hand, in a high temperature (high humidity) environment and a low temperature (low humidity) environment that largely influence the life of the motor that drives the air pump 12, the evaluation of the air pump system is not performed (i.e., the motor is not used), but the evaluation of the EONV system is performed in place of the evaluation of the air pump system, so that the life of the airtightness evaluation device 10 is extended. Furthermore, even under a situation in which the evaporated fuel may ignite, the evaluation of the EONV system is performed, and thus the airtightness is safely evaluated. It is noted that prior to the evaluation, the purge solenoid valve 4 should be put in a valve closed state.

The ECU 15 acquires information such as a traveling state and the opening of the purge solenoid valve 4 from a vehicle side to estimate the gas concentration of the evaporated fuel of the pipe 5, and acquires a pipe internal temperature T from the thermometer 7 (Step ST1). Then, the ECU 15 confirms whether the pipe internal temperature T is within a predetermined temperature range of T_{L}° C. to T_{H}° C. (Step ST2), and whether the gas concentration of the evaporated fuel is not greater than predetermined concentration (Step ST3), as a condition for performing the evaluation of the air pump system. As the temperature range of T_{L}° C. to T_{H}° C., a temperature range that has little influence on the life of the motor of the air pump 12 is preferably set. Additionally, as the gas concentration of the evaporated fuel, for example, a gas concentration at which ignition to gasoline may be caused (e.g., 1%) is preferably set.

In a case where the condition for the evaluation of the air pump system is satisfied (“YES” in Step ST2 and “YES” in Step ST3), the ECU 15 drives only the air pump 12 (Step ST4), and confirms whether a current value (load) of the motor is not greater than a predetermined value (Step ST5), in order to confirm the presence or absence of the abnormality (internal dew condensation, freezing etc.) of the air pump 12, and the failure (short circuit etc.) of the motor that drives the air pump 12.

On the other hand, in a case where the condition for the evaluation of the air pump system is not satisfied (“NO” in Step ST2 and “NO” in Step ST3), the ECU 15 suspends the evaluation of the air pump system, the evaluation of the EONV system is performed (Steps ST7 to ST9). Additionally, also in a case where the current value of the motor is abnormal (“NO” in Step ST5), the ECU 15 stops the air pump 12 (Step ST6), and then performs the evaluation of the EONV system (Steps ST7 to ST9).

As the predetermined condition for switching between the air pump system and the EONV system, humidity, dust concentration, or the like may be used, in addition to the evaporated fuel gas concentration of the pipe 5, the internal temperature of the pipe 5, and the load of the motor that drives the air pump 12 as mentioned above.

In a case where the evaluation of the EONV system is performed, the ECU 15 closes the canister vent solenoid valve 11 to block the pipe 5 from the atmosphere (Step ST7), acquires a pipe internal pressure P from the pressure gauge 6, and evaluates whether or not the variation width of the pipe internal pressure P (i.e., EONV system evaluation pressure) accompanying the change of the fuel temperature after the stop of the engine (stop of the vehicle) is within a predetermined variation range (Step ST8). In a case where the variation in the pipe internal pressure P varies in conjunction with the variation of the temperature (“OK” in Step ST9), the ECU 15 determines that no leakage from the pipe 5 occurs. On the other hand, when the leakage occurs due to an opened hole in the pipe 5 or the like, the pipe 5 comes to be communicated with the atmosphere, and no variation of the pipe internal pressure P occurs with the temperature variation. Accordingly, in a case where no variation in the pipe internal pressure P occurs (“NG” in Step ST9), the ECU 15 determines that the leakage from the pipe 5 occurs.

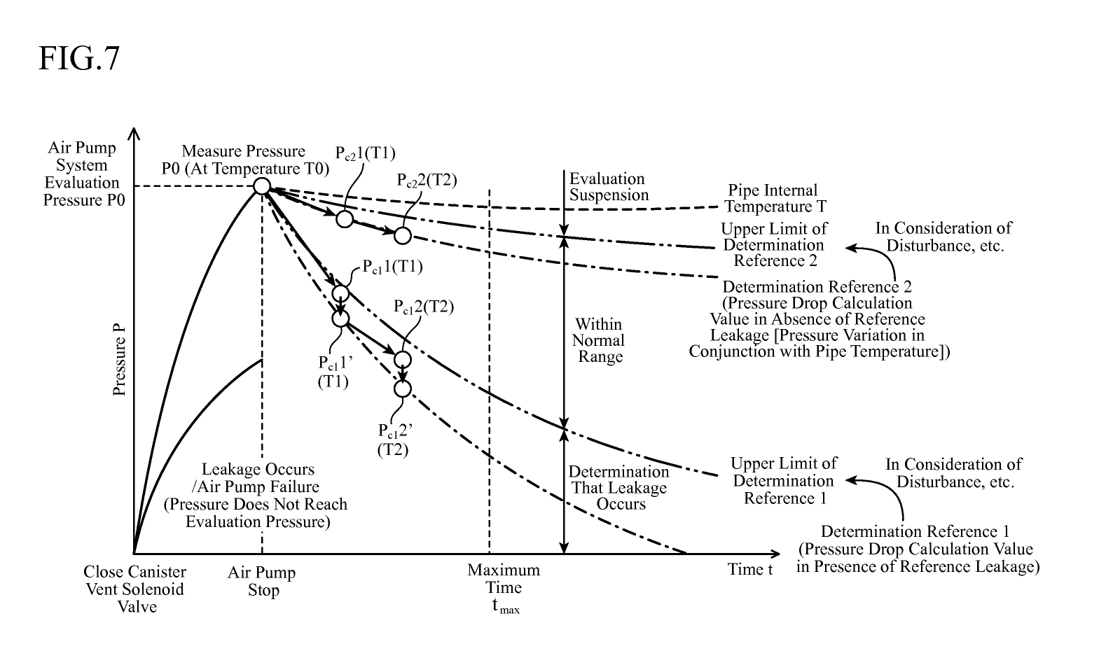

In this connection, FIG. 7 shows a graph of a pressure curve used in the air pump system evaluation. The horizontal axis of the graph shows time, and the vertical axis thereof shows the internal pressure of the pipe 5. Hereinafter, an evaluation method of the air pump system will be described with reference to FIG. 7.

In a case where the evaluation of the air pump system is performed, the ECU 15 first closes the canister vent solenoid valve 11 in order to seal the pipe 5 (Step ST10). After closing the valve, the ECU 15 drives the air pump 12 until the pipe internal pressure P measured by the pressure gauge 6 reaches the air pump system evaluation pressure. As shown in a solid line in FIG. 7, in a case where the pipe internal pressure P reaches the air pump system evaluation pressure within a predetermined time from the closing of the canister vent solenoid valve 11 (“YES” in Step ST11), the ECU 15 stops the air pump 12 (Step ST17). Also in a case where the pipe internal pressure P does not reach the air pump system evaluation pressure within the predetermined time (“NO” in Step ST11), the ECU 15 stops the air pump 12 (Step ST12).

In the case where the pipe internal pressure P does not reach the air pump system evaluation pressure within the predetermined time (“NO” in Step ST11), the ECU 15 stops the air pump 12 (Step ST12), thereafter opens the canister vent solenoid valve 11 temporarily to return the pipe internal pressure P to atmospheric pressure (Step ST13), and performs the evaluation of the EONV system similarly to Steps ST7 to ST9 (Steps ST14 to ST16). In a case where the variation in the pipe internal pressure P is within the predetermined variation range (“OK” in Step ST16), the ECU 15 determines that the air pump 12 is out of order. On the other hand, in a case where no pipe internal pressure P varies (“NG” in Step ST16), the ECU 15 determines that the leakage occurs due to a large hole in the pipe 5.

In the case where the pipe internal pressure P reaches the air pump system evaluation pressure within the predetermined time (“YES” in Step ST11), the ECU 15 stops the air pump 12 (Step ST17). At the same time as the stop of the air pump 12, the check valve 13 serially connected to the air pump 12 is operated, and the pipe 5 is sealed, so that the pipe internal pressure P is held. The pipe internal pressure P after the stop of the air pump 12 varies depending on the leakage amount of the pipe 5 and the pipe internal temperature T. Therefore, in the air pump system evaluation, the pipe internal pressure P actually measured by the pressure gauge 6 is compared with upper limits of determination references 1 and 2 (shown by two-dot chain lines in FIG. 7), thereby determining the presence or absence of the leakage of the pipe 5 (Steps ST18 to ST33). As the determination reference 1 (shown by a dashed line in FIG. 7), a curve obtained by correcting the “pipe internal pressure” calculated from the “pipe internal volume” and the “leakage amount calculated from the pipe internal pressure” by the “pipe internal temperature variation” is used. Also, as the determination reference 2 (shown by a dashed line in FIG. 7), a curve obtained by correcting the “pipe internal pressure” in a case where no leakage occurs by the “pipe internal temperature variation” is used. Furthermore, taking into consideration a measured value error, disturbance, and the like, the upper limits of the determination references 1 and 2 having a predetermined margin is calculated; in a case where a measured pressure is deviated from the determination references 1 and 2 to some extent, it is determined that the leakage occurs, or the failure of the thermometer 7 or the like occurs (suspension of the evaluation). The predetermined margin may be changed in accordance with the pipe internal temperature, the pipe internal pressure, or the like, or may be constant.

In a case where the pipe internal pressure P exceeds the air pump system evaluation pressure to excessively rise due to the failure of the air pump 12 or the like, and reaches the opening valve pressure of the canister vent solenoid valve 11 within the predetermined time, the canister vent solenoid valve 11 is opened and the pipe internal pressure P is lowered based on the setting of the above expression (1).

In the case where the evaluation of the air pump system is performed, the ECU 15 first acquires a pipe internal pressure (hereinafter, referred to as measured pipe internal pressure) P0 measured by the pressure gauge 6 right after the stop of the air pump 12, and acquires a pipe internal temperature (hereinafter, referred to as measured pipe internal temperature) T0 measured by the thermometer 7 right after the stop of the air pump 12 (Step ST18). Then, the ECU 15 estimates a reference leakage amount Q_{L}0 in a case where it is assumed that a reference hole of φ0.5 mm is opened in the pipe 5, and the measured pipe internal pressure is the measured pipe internal pressure P0 (Step ST19). Note that the reference leakage amount may be estimated, assuming a hole other than the one of φ0.5 mm.

The ECU 15 estimates a pressure drop calculation value P_{C1}1 in the presence of a reference leakage after t seconds, on the basis of the reference leakage amount Q_{L}0 and the volume V of the pipe 5 (Step ST20), waits for t seconds (Step ST21), and thereafter acquires the measured pipe internal pressure P1 and the measured pipe internal temperature T1 from the pressure gauge 6 and thermometer 7, respectively (Step ST22). Then, the ECU 15 corrects the pressure drop calculation value P_{C1} in the presence of the reference leakage in accordance with the temperature variation amounts of the measured pipe internal temperatures T0 and T1, to calculates a temperature-corrected pressure drop calculation value P_{C1}1′ in the presence of the reference leakage, and corrects the measured pipe internal pressure P0 in accordance with the temperature variation amounts of the measured pipe internal temperatures T0 and T1, to calculate a temperature-corrected pressure drop calculation value P_{C2}1 in the absence of the reference leakage (Step ST23). The pressure drop calculation value P_{C1}1′ in the presence of the reference leakage is equivalent to the determination reference 1, the pressure drop calculation value P_{C2}1 in the absence of the reference leakage is equivalent to the determination reference 2.

Note that the volume V of the pipe 5 can be calculated as a value obtained by deducting a residual amount of fuel from the volume of the fuel tank 1 and the volume of the pipe 5, and the ECU 15 may simply acquire these pieces of information from the vehicle side to calculate the volume V.

Subsequently, the ECU 15 compares the measured pipe internal pressure P1 after t seconds from the stop of the air pump 12 with the upper limit of the determination reference 2 obtained by providing the predetermined margin to the determination reference 2 in the absence of the reference leakage (Step ST24). In a case where the measured pipe internal pressure P1 exceeds the upper limit of the determination reference 2 (“YES” in Step ST24), the failure of thermometer 7 or the like is suspected, and therefore the ECU 15 suspends the evaluation. In a case other than the above (“NO” in Step ST24), the process advances to Step ST25 to determine the presence or absence of the leakage.

The ECU 15 compares the measured pipe internal pressure P1 with the upper limit of the determination reference 1 obtained by providing the predetermined margin to the determination reference 1 in the presence of the reference leakage. In a case where the measured pipe internal pressure P1 is lower than the upper limit of the determination reference 1 (“YES” in Step ST25), the ECU 15 determines that the leakage from the pipe 5 occurs. On the other hand, in a case where the measured pipe internal pressure P1 is larger than the upper limit of the determination reference 1 (“NO” in Step ST25), the ECU 15 determines that the pipe internal pressure is within a normal range, and the process advances to Step ST26.

In Steps ST18 to ST25 described above, the determination references 1 and 2 (P_{C1}1′ and P_{C2}1) after the lapse of t seconds from the stop of the air pump 12 are estimated by using the pipe internal pressure P0 measured right after the stop of the air pump 12. In Steps ST26 to ST33 described below, the determination references 1 and 2 (P_{C1}2′ and P_{C2}2) after the lapse of 2t seconds are estimated by using the determination references 1 and 2 after t seconds (P_{C1}1′ and P_{C2}1).

The ECU 15 estimates a reference leakage amount Q_{L}1 from the reference hole at the temperature-corrected pressure drop calculation value P_{C1}1′ in the presence of the reference leakage (Step ST26). Thereafter, the ECU 15 calculates a pressure drop calculation value P_{C1}2 in the presence of the temperature-corrected reference leakage after t seconds, on the basis of the reference leakage amount Q_{L}1 and the volume V of the pipe 5 (Step ST27), waits for t seconds (Step ST28), and thereafter acquires the measured pipe internal pressure P2 and the measured pipe internal temperature T2 from the pressure gauge 6 and the thermometer 7, respectively (Step ST29). Subsequently, the ECU 15 corrects the pressure drop calculation value P_{C1}2 in the presence of the reference leakage in accordance with the temperature variation amounts of the measured pipe internal temperatures T1 and T2, to calculate a temperature-corrected pressure drop calculation value P_{C1}2′ in the presence of the reference leakage, and corrects the pressure drop calculation value P_{C2}1 in the absence of a reference leakage in accordance with the temperature variation amounts of the measured pipe internal temperatures T1 and T2, to calculate the pressure drop calculation value P_{C2}2 in the absence of the reference leakage (Step ST30). The pressure drop calculation value P_{C1}2′ in the presence of the reference leakage is equivalent to the determination reference 1, and the pressure drop calculation value P_{C2}2 in the absence of the reference leakage is equivalent to the determination reference 2.

Subsequently, the ECU 15 compares the measured pipe internal pressure P2 after 2t seconds from the stop of the air pump 12 with the upper limit of the determination reference 2 obtained by providing the predetermined margin to the determination reference 2 in the absence of the reference leakage. In a case where the measured pipe internal pressure P2 exceeds the upper limit of the determination reference 2 (“YES” in Step ST31), the ECU 15 suspends the evaluation. Ina case other than the above (“NO” in Step ST31), the process advances to Step ST32, and the presence or absence of the leakage is determined.

The ECU 15 compares the measured pipe internal pressure P2 with the upper limit of the determination reference 1 obtained by providing the predetermined margin to the determination reference 1 in the presence of the reference leakage. In a case where the measured pipe internal pressure P2 is lower than the upper limit of the determination reference 1 (“YES” in Step ST32), the ECU 15 determines that the leakage from the pipe 5 occurs. On the other hand, in a case where the measured pipe internal pressure P2 is larger than the upper limit of the determination reference 1 (“NO” in Step ST32), the ECU 15 determines that the pipe internal pressure is within the normal range, and advances to Step ST33. Thereafter, when an elapsed time tₜₒₜₐₗ from right after the stop of the air pump 12 (Step ST17) is within a predetermined maximum time tₘₐₓ (“YES” in Step ST33), the ECU 15 repeatedly performs the processes of Steps ST26 to ST32. On the other hand, when the elapsed time t^{total} exceeds the maximum time tₘₐₓ (“NO” in Step ST33), the ECU 15 determines that the pipe internal pressure varies within the normal range, namely, no leakage occurs. After a series of the airtightness evaluation is completed, the ECU 15 opens the canister vent solenoid valve 11 in order to return the pipe internal pressure to the atmospheric pressure.

Note that in a case where the presence or absence of the leakage is determined (“YES” in Step ST25 and “YES” in Step ST32), the evaluation is completed at this point, so that the time required for the evaluation can be shortened as compared to the maximum time tₘₐₓ.

Additionally, in a case where the evaluation is suspended (“YES” in Step ST24 and “YES” in Step ST31), the evaluation may be performed again from Step ST1 after a while.

As mentioned above, in the air pump system evaluation of Embodiment 1, the leakage presence or absence of the pipe 5 is determined by comparing the measured curves of pressure drop after the pipe internal pressure reaches the air pump system evaluation pressure with each of the curved lines of the upper limits of the determination references 1 and 2 of the pressure variation in conjunction with the pipe internal temperatures at the times when the reference leakage occurs and when the reference leakage does not occur, and therefore it is possible to preclude variation in the size of components for the evaluation such as the canister vent solenoid valve 11, the air pump 12, and the check valve 13, aging deterioration, and influence due to change in evaluation environment. Additionally, the variation in the size of the components for the evaluation can be allowed, and therefore the cost can be suppressed. Furthermore, the pressure drop calculation value is temperature-corrected in consideration of the volume change of the evaporated fuel in accordance with the temperature variation, and therefore it is possible to improve the estimation precision of the determination references 1 and 2, and to ensure precise leakage evaluation even against external disturbance (some kind of heating or cooling of the pipe 5).

On the contrary, in a case where the leakage evaluation is performed on the basis of the gradient of the pipe internal pressure during the pressure application (during the driving of the air pump) like the conventional, the air pump 12 needs to have a high-precision flow rate characteristic, so that the cost is increased. Additionally, in a case where a reference hole such as an orifice is used, environmental resistance and initial precision of the reference hole are required, so that the cost is increased.

As described above, according to Embodiment 1, the airtightness evaluation device 10 is configured to include: the air pump 12 that changes the internal pressure of the evaporated fuel processing system; the canister vent solenoid valve 11 that is installed in the pipe which communicates the canister 2 with the atmosphere; and the ECU 15 that performs the driving control of the air pump 12 and the opening/closing control of the canister vent solenoid valve 11, and detects the internal pressure of the evaporated fuel processing system to thereby evaluate the airtightness, wherein the ECU 15 performs airtightness evaluation by switching between the air pump system evaluation in which the air pump 12 is driven and the internal pressure is pressurized in a state where the canister vent solenoid valve 11 is closed and the evaporated fuel processing system is blocked from the atmosphere, and thereafter the airtightness is evaluated on the basis of the variation in the internal pressure in a state where the air pump 12 is stopped, and the EONV system evaluation in which the airtightness is evaluated on the basis of the variation in the internal pressure with the fuel temperature change in a state where the canister vent solenoid valve 11 is closed, and the evaporated fuel processing system is blocked from the atmosphere. Therefore, the airtightness can be evaluated by the air pump system evaluation using the air pump 12 without being affected by an engine driving state. Additionally, the airtightness is evaluated on the basis of the variation in the internal pressure after the evaporated fuel processing system is pressurized in the air pump system evaluation, and therefore components such as a high-precision air pump and a conventional high-precision orifice as in the conventional are not required, and the airtightness evaluation device 10 can be configured at a low cost.

In addition, according to Embodiment 1, the airtightness evaluation device 10 is configured to include the check valve 13 that is installed between the evaporated fuel processing system and the air pump 12, and opens/closes in accordance with the differential pressure, wherein the opening valve pressure of the check valve 13, and the discharge pressure of the air pump 12 at the time when the internal pressure of the evaporated fuel processing system is pressurized are set so as to become larger in this order as compared to the EONV system evaluation pressure, and the check valve 13 opens when receiving the discharge pressure of the air pump 12, but does not open when receiving the EONV system evaluation pressure. Therefore, it is possible to perform the evaluation of the air pump system and the evaluation of the EONV system with the same configuration of the components. Additionally, although a high-precision component size is conventionally requested in order to control the discharge pressure of the air pump 12, it is possible to lower the component precision and thus suppress the cost by the above setting.

In addition, according to Embodiment 1, the ECU 15 is configured so as to switch between the air pump system evaluation and the EONV system evaluation in accordance with the evaporated fuel gas concentration in the evaporated fuel processing system. Therefore, in a state where ignition to the evaporated fuel is concerned (evaporated fuel gas high concentration), the evaluation can be switched to the EONV system evaluation in which the air pump 12 is not used. Additionally, a cost required for a countermeasure against explosion can be suppressed, and therefore the airtightness evaluation device 10 can be configured at a low cost.

Further, according to Embodiment 1, the ECU 15 is configured so as to switch between the air pump system evaluation and the EONV system evaluation in accordance with the load of the motor that drives the air pump 12. Therefore, the evaluation can be switched to the EONV system evaluation in which the air pump 12 is not used, at the time of the failure (short circuit) of the motor.

Furthermore, according to Embodiment 1, the ECU 15 is configured so as to switch between the air pump system evaluation and the EONV system evaluation in accordance with the internal temperature of the evaporated fuel processing system. Therefore, in a state that largely influences the life of the motor (a high temperature and a low temperature), the evaluation can be switched to the EONV system evaluation in which the air pump 12 is not used.

Moreover, according to Embodiment 1, the ECU 15 is configured so as to switch to the EONV system evaluation, in a case where the internal pressure does not reach the target pressure (air pump system evaluation pressure) within the predetermined time, when the ECU 15 drives the air pump 12 to pressurize the internal pressure of the evaporated fuel processing system in the air pump system evaluation. Therefore, in an abnormal situation in which the internal pressure does not rise even when the evaporated fuel processing system is pressurized by the air pump 12 (“NO” in Step ST11), the evaluation is switched from the air pump system evaluation to the EONV system evaluation, so that it is possible to determine whether the abnormal situation is an abnormality resulting from leakage from the evaporated fuel processing system, or an abnormality resulting from the failure of the air pump 12 (internal dew condensation, freezing, or the like).

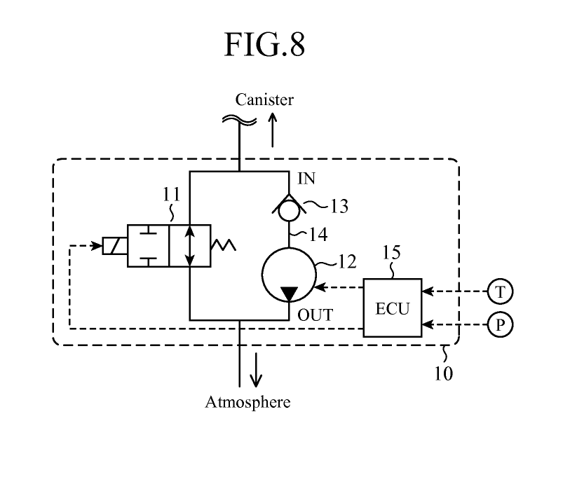

In the air pump system evaluation of Embodiment 1, the pipe 5 is pressurized by using the air pump 12. However, on the contrary, the pipe 5 may be depressurized by using the air pump 12. FIG. 8 shows a configuration of the airtightness evaluation device 10 in a case where the evaporated fuel processing system is depressurized. In FIG. 8, the suction side of the air pump 12 is connected to the pipe 5 through the check valve 13, and the discharge side is connected to the atmosphere side through a filter (not shown). Additionally, the relation among the suction pressure of the air pump 12, the valve opening force of the check valve 13, and the EONV system evaluation pressure in this configuration satisfies the following expression (2). Consequently, the check valve 13 can seal the pipe 5 in each of the air pump system evaluation and the EONV system evaluation, and precise evaluation can be performed on the basis of the variation in the internal pressure. Additionally, in a case where the internal pressure of the pipe 5 is excessively lowered, the canister vent solenoid valve 11 opens, and therefore it is possible to prevent the deformation of the fuel tank 1 or the like.

|Suction Pressure of Air Pump|>|Opening Valve Pressure of Canister Vent Solenoid Valve|>|Air Pump System Evaluation Pressure|>|Opening Valve Pressure of Check Valve|>|EONV System Evaluation Pressure| (2)

In a case where the pipe 5 is depressurized by the air pump system evaluation, the air pump system evaluation pressure is not necessarily set to a value greater than the opening valve pressure of the check valve 13, but may be set to a value lower than the opening valve pressure of the check valve 13 (e.g., almost the same as the EONV system evaluation pressure). This is because, in a case of the depressurization, when the check valve 13 can be opened by the suction pressure of the air pump 12 to thus feed the air from the pipe 5, the internal pressure of the pipe 5 can be arbitrarily depressurized by an amount of the fed air.

In addition, in Embodiment 1 described above, the evaluation of the EONV system is performed as the second evaluation system. However, the evaluation of the engine vacuum system may be performed as the second evaluation system. In this case, in the flowcharts of FIG. 6A and FIG. 6B, the evaluation of the engine vacuum system is performed in Steps ST8 and ST15. In the engine vacuum system evaluation, the ECU 15 opens the purge solenoid valve 4 to depressurize the evaporated fuel processing system with an engine vacuum in a state blocking the evaporated fuel processing system from the atmosphere by closing the canister vent solenoid valve 11, and thereafter evaluates the airtightness on the basis of the variation in the internal pressure in a state where the purge solenoid valve 4 is closed, the check valve 13 is closed by the differential pressure, and the evaporated fuel processing system is sealed.

Additionally, in a case where the evaluation of the engine vacuum system is performed as the second evaluation system, |EONV System Evaluation Pressure| is replaced by |Engine Vacuum System Evaluation Pressure| in the above expressions (1) and (2). The engine negative pressure system evaluation pressure indicates a value of variation in the internal pressure in a state where the pipe 5 is sealed after the pipe 5 is depressurized by the engine vacuum.

Note that the present invention can be implemented by modification of arbitrary components of the embodiment, or omission of arbitrary components of the embodiment, within the scope of the invention.

### INDUSTRIAL APPLICABILITY

As described above, the airtightness evaluation device according to the present invention performs the evaluation by switching between the evaluation of the air pump system and the evaluation of the EONV system (or the engine vacuum system), and therefore it is suitable for use in an airtightness evaluation device that evaluates the airtightness of an evaporated fuel processing system equipped in a plug-in hybrid vehicle reducing engine driving itself, or the like.

### DESCRIPTION OF REFERENCE NUMERALS

1: FUEL TANK

2: CANISTER

3: INLET MANIFOLD

4: PURGE SOLENOID VALVE

5, 14: PIPE

6: PRESSURE GAUGE

7: THERMOMETER

10: AIRTIGHTNESS EVALUATION DEVICE

11: CANISTER VENT SOLENOID VALVE

12: AIR PUMP

13: CHECK VALVE

15: ECU.

1. An airtightness evaluation device that evaluates airtightness of an evaporated fuel processing system which recovers evaporated fuel of a fuel tank with a canister to introduce the evaporated fuel to an engine,
the device comprising:
an air pump that changes an internal pressure of the evaporated fuel processing system;
a solenoid valve that is installed in a pipe which communicates the canister with atmosphere; and
a controller that performs driving control of the air pump and opening/closing control of the solenoid valve, and detects the internal pressure of the evaporated fuel processing system to evaluate the airtightness, wherein
in a case where a predetermined condition is satisfied, the controller drives the air pump to pressurize or depressurize the internal pressure in a state blocking the evaporated fuel processing system from the atmosphere by closing the solenoid valve, and thereafter performs a first evaluation system of evaluating the airtightness on the basis of a variation in the internal pressure in a state stopping the air pump, whereas in a case where the predetermined condition is not satisfied, the controller performs a second evaluation system of evaluating the airtightness on the basis of the variation in the internal pressure in the state blocking the evaporated fuel processing system from the atmosphere by closing the solenoid valve.

2. The airtightness evaluation device according to claim 1, further comprising
a check valve that is installed between the evaporated fuel processing system and the air pump, and opens/closes in accordance with a differential pressure, wherein as compared to the internal pressure of the evaporated fuel processing system at the time when the second evaluation system is being performed, an opening valve pressure of the check valve and a discharge pressure of the air pump at the time when the internal pressure is pressurized are set to become larger in this order, and the check valve opens when receiving the discharge pressure of the air pump, but does not open when receiving the internal pressure at the time when the second evaluation system is being performed.

3. The airtightness evaluation device according to claim 1, further comprising
a check valve that is installed between the evaporated fuel processing system and the air pump, and opens/closes in accordance with a differential pressure, wherein as compared to the internal pressure of the evaporated fuel processing system at the time when the second evaluation system is being performed,
an opening valve pressure of the check valve and a suction pressure of the air pump at the time when the internal pressure is depressurized are set to become larger in this order, and the check valve opens when receiving the suction pressure of the air pump, but does not open when receiving the internal pressure at the time when the second evaluation system is being performed.

4. The airtightness evaluation device according to claim 1, wherein
the controller uses an evaporated fuel gas concentration of the evaporated fuel processing system as the predetermined condition, and switches between the first evaluation system and the second evaluation system in accordance with the evaporated fuel gas concentration.

5. The airtightness evaluation device according to claim 1, wherein
the controller uses a load of a motor that drives the air pump as the predetermined condition, and switches between the first evaluation system and the second evaluation system in accordance with the load.

6. The airtightness evaluation device according to claim 1, wherein
the controller uses an internal temperature of the evaporated fuel processing system as the predetermined condition, and switches between the first evaluation system and the second evaluation system in accordance with the internal temperature.

7. The airtightness evaluation device according to claim 1, wherein
the controller implements switching to the second evaluation system, in a case where the internal pressure does not reach a target pressure within a predetermined time, when the controller drives the air pump to pressurize or depressurize the internal pressure of the evaporated fuel processing system in the first evaluation system.

8. An airtightness evaluation method of evaluating airtightness of an evaporated fuel processing system which recovers evaporated fuel of a fuel tank with a canister to introduce the evaporated fuel to an engine,
the method comprising:
in a case where a predetermined condition is satisfied, providing a state blocking the evaporated fuel processing system from atmosphere by closing a solenoid valve installed in a pipe that communicates the canister with the atmosphere, and driving the air pump to pressurize or depressurize an internal pressure of the evaporated fuel processing system, and thereafter performing a first evaluation system of evaluating the airtightness on the basis of a variation in the internal pressure in a state stopping the air pump, whereas in a case where the predetermined condition is not satisfied, performing a second evaluation system of evaluating the airtightness on the basis of the variation in the internal pressure in the state blocking the evaporated fuel processing system from the atmosphere by closing the solenoid valve.
